(19) United States
(12) Patent Application Publication
(10) Pub. No.: US 2023/0015090 A1
(43) Pub. Date: Jan. 19, 2023

(54) Systems and Methods for Dynamically Classifying Products and Assessing Applicability of Product Regulations

(71) Applicant: UL LLC, Northbrook, IL (US)

(72) Inventors: Spencer Sharpe, Laramie, WY (US); Michael Arnold, Duvall, WA (US); Lisa Epstein, Boston, MA (US)

(21) Appl. No.: 17/948,152

(22) Filed: Sep. 19, 2022

Related U.S. Application Data
(63) Continuation-in-part of application No. 16/710,561, filed on Dec. 11, 2019, now Pat. No. 11,475,493.
(60) Provisional application No. 63/270,458, filed on Oct. 21, 2021.

(51) Int. Cl. G06Q 30/02; G06N 5/02

(52) U.S. Cl. CPC G06Q 30/0204; G06N 5/022

(57) ABSTRACT

Systems and methods for dynamically determining potentially applicability of product regulation updates and regulatory requirement rules and representations to product profiles, as well as map product taxonomies. According to certain aspects, an electronic device may access new or updated product regulation updates for various jurisdictions as well as product profiles associated with certain products. The electronic device may employ various data analysis technologies to determine which product regulation updates are potentially applicable to which product profiles. The electronic device may present information associated with the data analyses, and enable users to review information, further assess applicability, make selections, and interface and integrate with external systems to exchange information and insights.

### CROSS-REFERENCE TO RELATED APPLICATIONS

This application is a continuation-in-part application of U.S. patent application Ser. No. 16/710,561 (filed Dec. 11, 2019 and entitled “METHODS FOR DYNAMICALLY ASSESSING APPLICABILITY OF PRODUCT REGULATION UPDATES TO PRODUCT PROFILES”). This application also claims benefit of the filing date of U.S. Provisional Patent Application No. 63/270,458 (filed Oct. 21, 2021 and entitled “PRODUCT TAXONOMY MAPPING INITIALIZED WITH SEQUENCE-TO-SEQUENCE HIERARCHICAL PATH TRANSLATIONS”). These applications are hereby incorporated by reference in their entireties.

### FIELD

The present disclosure is directed to dynamically assessing applicability of product regulation updates to product profiles associated with items such as consumer products. More particularly, the present disclosure is directed to platforms and technologies for using various data analysis techniques to determine how products may be affected by applicable regulation updates based on specified product profiles. Additionally, the present disclosure is directed to entity alignment.

### BACKGROUND

The amount and scope of consumer products available for sale in the marketplace is constantly changing as new products are introduced and existing products are improved or modified. In particular, product manufacturers, distributors, and the like will consistently release new products and update existing products to meet consumer demand and to compete with other manufacturers, distributors, and the like. Generally, a product is specified according to a product profile which defines or describes the product, features thereof, compliance requirements, brand claims, and/or other aspects, and serves to describe the differentiators of the product. The introduction and sale of products into the marketplace is subject to governance in the form of regulations, laws, and standards. Typically, different jurisdictions (e.g., federal, state, county, etc.) have different regulations for different products. For example, California may regulate lithium-ion batteries differently than Texas. However, in addition to detailing different requirements, regulations are often not consistent in terminology, scope, or applicability, among other inconsistencies. Additionally, product profiles are not consistent in breadth and terminology, among other inconsistencies. Therefore, entities associated with products (e.g., retailers, manufactures, suppliers, etc.) are not able to effectively determine which regulations may be applicable for certain products, especially new or updated products.

Additionally, there may be a long lead time between the product profile being defined and the product being manufactured and delivered, during which existing regulations may be modified, updated, and/or new regulations introduced. Any such modification or update to product regulations determined to be applicable for certain products may impact their corresponding applicability for those products, and/or may cause those product regulations to be applicable to an entirely new product(s). Moreover, for products already introduced in the marketplace, such regulation updates may have significant impacts by changing the applicable regulations and causing manufacturers to re-evaluate, and possibly update, product profiles despite satisfying all formerly-applicable regulations.

Moreover, regulatory intelligence (RI) is a set of tools and services that help product manufacturers and retailers understand their compliance requirements in the markets they intend to serve. As companies increase their global reach, and as regulations are issued by governmental bodies at an accelerating pace, the problem of manually finding which regulations apply to their products in different locales quickly becomes unmanageable. Given that regulators usually express policy requirements in terms of vendor-neutral product categories, the adoption of vendor-neutral product taxonomies such as GS1's Global Product Classification (GPC) standard, Harmonized System (HS) Codes or the like can be useful in automatic entity alignment applications. Additionally, the representation of regulations in the context of standardized representation or identification of product features such as attributes, components, chemicals, materials, and the like may facilitate aligning regulations with products covered by them.

Accordingly, there is an opportunity for platforms and technologies that effectively and efficiently determine applicability of compliance requirements from regulations and regulation updates to products and their respective features. Additionally, these technologies function through alignment techniques that may utilize machine learning to analyze rules and representations of compliance requirements as they relate to products and their respective attributes.

### SUMMARY

In an embodiment, a computer-implemented method for dynamically determining potential impacts of product regulation updates on product profiles is provided. The method may include: accessing, by a processor, a set of product regulation update alerts; extracting, by the processor, a set of product regulation updates from the set of product regulation update alerts; storing, in memory, the set of product regulation updates; accessing, by the processor, a set of product profiles associated with a set of products for a given market(s), wherein each product profile of the set of product profiles comprises content descriptive of a corresponding product of the set of products; analyzing, by the processor for each product profile of the set of product profiles, the content descriptive of the corresponding product to determine whether at least one product regulation update of the set of product regulation updates is potentially applicable to the product profile; and displaying, in a user interface, a result of the analyzing.

In another embodiment, a system for dynamically determining impacts of product regulation updates on product profiles is provided. The system may include a memory storing instructions; a user interface; and a processor interfaced with the memory and the user interface. The processor may be configured to execute the instructions to cause the processor to: access a set of product regulation update alerts, extract a set of product regulation updates from the set of product regulation update alerts, cause the memory to store the set of product regulation updates, access a set of product profiles associated with a set of products for a given market(s), wherein each product profile of the set of product profiles comprises content descriptive of a corresponding product of the set of products for a given market(s), analyze, for each product profile of the set of product profiles, the content descriptive of the corresponding product to determine whether at least one product regulation update of the set of product regulation updates is potentially applicable to the product profile, and cause the user interface to display a result of the analyzing.

In a further embodiment, a non-transitory computer-readable storage medium having stored thereon a set of instructions, executable by a processor, for dynamically determining impacts of product regulation updates on product profiles is provided. The instructions may include: instructions for accessing a set of product regulation update alerts; instructions for extracting a set of product regulation updates from the set of product regulation update alerts; instructions for storing, in memory, the set of product regulation updates; instructions for accessing a set of product profiles associated with a set of products for a given market(s), wherein each product profile of the set of product profiles comprises content descriptive of a corresponding product of the set of products for a given market(s); instructions for analyzing, for each product profile of the set of product profiles, the content descriptive of the corresponding product to determine whether at least one product regulation update of the set of product regulation updates is potentially applicable to the product profile; and instructions for displaying, in a user interface, a result of the analyzing.

In a further embodiment, new entities relating to products and compliance requirements may be aligned with existing entities as a means to evaluate entities that do not yet have a defined identifier as it pertains to an application. This may be achieved via review of entities against a knowledgebase or a knowledge graph with potential use of machine learning models to assist for matching (i.e., entity alignment). This may also involve leveraging standardized taxonomies as a means to align entities.

### BRIEF DESCRIPTION OF THE FIGURES

FIG. 1A depicts an overview of components and entities associated with the systems and methods, in accordance with some embodiments.

FIG. 1B depicts an overview of certain components configured to facilitate the systems and methods, in accordance with some embodiments.

FIGS. 2A-2D depict example interfaces associated with reviewing product profiles and product regulation updates, in accordance with some embodiments.

FIGS. 3A-3F depict example interfaces associated with reviewing product profiles and product regulation updates, in accordance with some embodiments.

FIG. 4 is an example flowchart associated with dynamically determining applicable product regulation updates, in accordance with some embodiments.

FIG. 5 depicts an overview of datasets and components that access and analyze the datasets in association with the taxonomy mapping, in accordance with some embodiments.

### DETAILED DESCRIPTION

The present embodiments may relate to, inter alia, platforms and technologies for dynamically assessing applicability of product regulation updates to product profiles. According to certain aspects, systems and methods may receive or otherwise access information indicative of product regulation updates, and may organize and store the information as part of a machine learning model or other data organization structure. The systems and methods may additionally receive or access information indicative of product profiles, such as descriptions of products that are in the marketplace or are being proposed for entry into the marketplace.

The systems and methods may analyze the information indicative of the product profiles, with reference to the product regulation update information, to determine which regulations may be applicable to the associated products. The systems and methods may analyze the information using any stored data model(s) or according to other data analysis techniques. The systems and methods may present information that indicates the potentially applicable regulation updates from a regulatory feed and their potential applicability to certain products for review, selection, and/or correction by certain users, and may represent information in an encoded machine-readable format, using ontologies or other schemas to link facts about product and requirement information with testing protocols or other business logic fulfillment systems. In embodiments, the interaction with the presented information by the users may be captured and input into the machine learning model to increase the accuracy of subsequent regulation update assessments and determinations. Additionally, feedback from users may be used to assess the quality of the regulatory update assessments, thus enabling contextualization to the target environment, marketplace, or audience.

The systems and methods therefore offer numerous benefits. In particular, the use of various data analyses such as machine learning techniques enable the systems and methods to accurately and dynamically assess regulation update applicability to products based on the representation of relationships between products and compliance requirements. Additionally, these representations may include entities such as companies and corporations associated with a product lifecycle, who are afforded the benefit of being able to review regulation updates that are potentially applicable to products that the entities intend to release or introduce. Accordingly, the entities may make necessary adjustments or modifications to the products or to the release/introductions of the products, to comply with the applicable regulation updates, which may then be re-encoded to update semantic knowledge representations within the systems. Additionally, consumers would benefit from products that comply with current and proposed regulations and that experience a reduced amount of product recalls. It should be appreciated that additional benefits are envisioned, such as general benefits for the consumer base.

The systems and methods discussed herein address a challenge that is particular to supply chain management including market access and evaluating in-market performance. In particular, the challenge relates to a difficulty in accurately and effectively assessing which product regulation updates may be applicable to products before or during the introduction of the products to the market, especially because of inconsistencies between and among product profiles and product regulation updates. Conventionally, individuals must manually review product regulation updates to determine the impact to the corresponding regulation and the applicable products. However, these conventional methods are often time consuming, ineffective, and/or expensive due to the inherent complexity of tracking individual regulation updates. Additionally, the individuals may not have access to up-to-date regulatory changes, which can pose particularly significant issues for products currently available in the marketplace. The systems and methods offer improved capabilities to solve these problems by dynamically and accurately assessing regulation update applicability to products based on up-to-date information and machine learning techniques. Further, because the systems and methods employ communication between and among multiple devices, the systems and methods are necessarily rooted in computer technology in order to overcome the noted shortcomings that specifically arise in the realm of supply chain management.

Additionally, one of the main requirements of retailers, suppliers, manufacturers, and other service providers is to be able to onboard new vendor-specific product taxonomies and map them to regulations. A mechanism of achieving this to map vendor-specific taxonomies to a standard product taxonomy which is mapped to regulations through semantic representation of the data via an internal knowledge base.

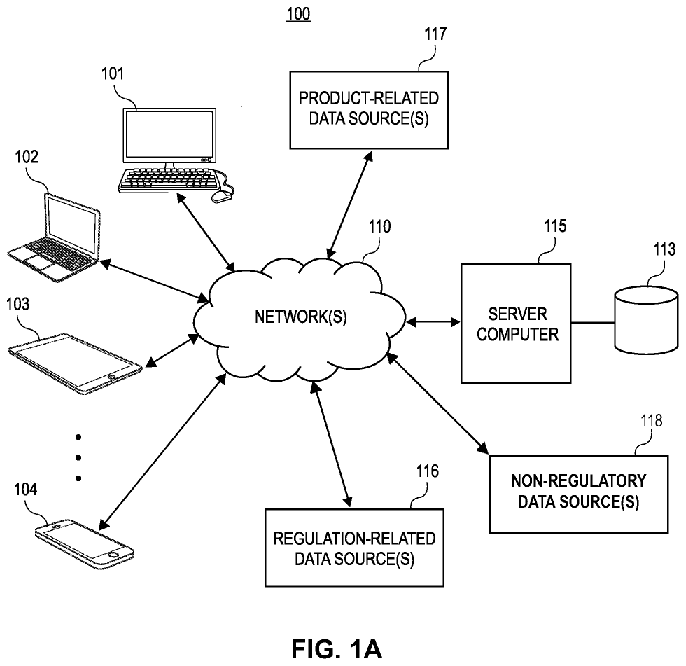

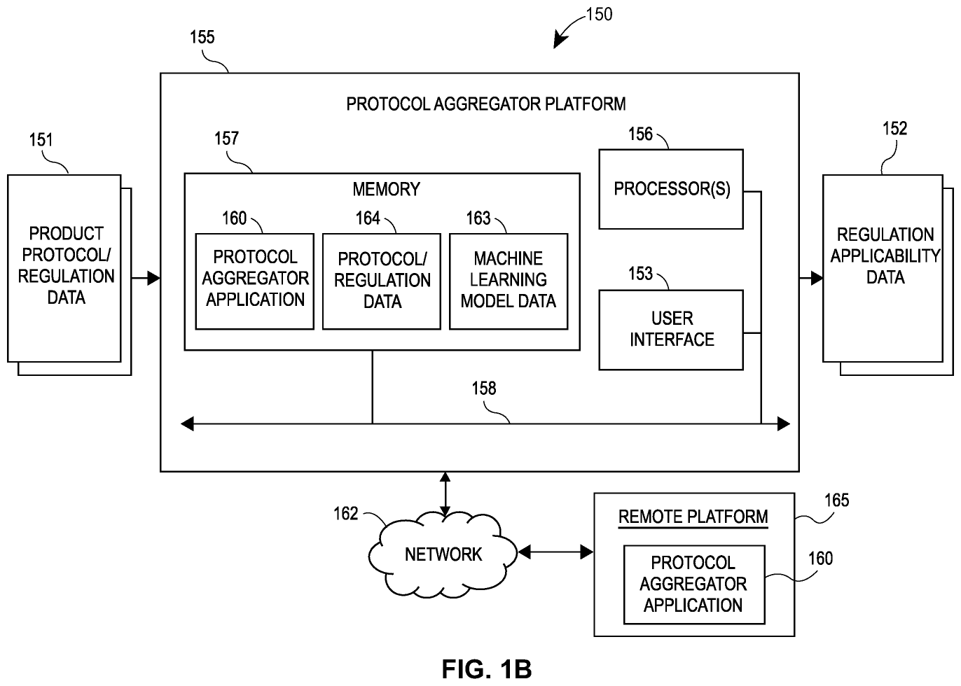

FIG. 1A illustrates an overview of a system 100 of components configured to facilitate the systems and methods. It should be appreciated that the system 100 is merely an example and that alternative or additional components are envisioned.

As illustrated in FIG. 1A, the system 100 may include a set of electronic devices 101, 102, 103, 104. Each of the electronic devices 101, 102, 103, 104 may be any type of electronic device such as a mobile device (e.g., a smartphone), desktop computer, notebook computer, tablet, phablet, GPS (Global Positioning System) or GPS-enabled device, smart watch, smart glasses, smart bracelet, wearable electronic, PDA (personal digital assistant), pager, computing device configured for wireless communication, and/or the like. In embodiments, any of the electronic devices 101, 102, 103, 104 may be an electronic device associated with an entity such as a company, business, corporation, or the like (e.g., a server computer or machine).

Each of the electronic devices 101, 102, 103, 104 may be used by any individual or person (generally, a user). According to embodiments, the user may use the respective electronic device 102, 102, 103, 104 to input information associated with a product(s). The product(s) may be offered for sale or otherwise made available for purchase, distribution or use by a business, company, service provider, or the like. Alternatively or additionally, the business, company, service provider, or the like may be contemplating offering the product for sale or purchase. In embodiments, the information may represent an iteration, update, or new version of the product(s).

Generally, the information for each product may be in the form of a product profile that may include a profile scope; defining product characteristic(s); a set of product requirement(s) based on regulations, standards, and in some cases, retailer requirements; acceptable product deliverable(s) based on requirements, and/or other information. The product profile may be prepared or developed before or after a product concept is decided, before or after concept testing is completed, and/or before or after preliminary sales have been forecasted. The product profile may be based on estimates of market and/or consumer need, testing with target market customers and feedback relating thereto, initial sales projections, estimates of advertising and marketing expenditure to launch a product, and/or estimates of production cost, and may include product specifications such as dimensions, component parts or ingredients, assembly or installation information, as well as compliance and performance requirements such as chemical, electrical, flammability and/or other safety requirements, labeling requirements, performance requirements, and/or other information. Additionally, the product profile may include information about usage conditions, ideal applications, ideal environmental conditions of operation, and usage exceptions that restrict the use of a product to certain types of operators or require a special environment in which to operate the product safely. Although the embodiments discuss protocols for products, it should be appreciated that the systems and methods, and functionalities thereof, may extend to services offered by businesses, companies, service providers, or the like.

As an example, a product profile for a child scooter may identify the component parts and materials of the scooter, mechanical safety requirements, necessary labeling requirements, and other requirements per applicable standards and regulations. As an additional example, a product profile for a light bulb with wireless network connection capabilities may identify the electrical requirements, wattage output, supported communication protocols, and component materials.

According to embodiments, each product profile for each product may be manually generated by an individual or user and input into one of the electronic devices 101, 102, 103, 104 (or another electronic device), automatically generated by one of the electronic devices 101, 102, 103, 104 (or another electronic device), or a combination thereof. Further, each product profile may include any textual (i.e., alphanumeric) content, media content (e.g., audio, video, images, etc.), or a combination thereof.

The electronic devices 101, 102, 103, 104 may communicate with a server computer 115 via one or more networks 110. The server computer 115 may be associated with an entity such as a company, business, corporation, or the like, which markets, manufactures, or sells the product, or is otherwise involved in the supply chain of the product. In embodiments, the electronic devices 101, 102, 103, 104 may transmit or communicate, via the network(s) 110, information associated with product profiles to the server computer 115.

In embodiments, the network(s) 110 may support any type of data communication via any standard or technology including various wide area network or local area network protocols (e.g., GSM, CDMA, VoIP, TDMA, WCDMA, LTE, EDGE, OFDM, GPRS, EV-DO, UWB, Internet, IEEE 802 including Ethernet, WiMAX, Wi-Fi, Bluetooth, and others). Further, in embodiments, the network(s) 110 may be any telecommunications network that may support a telephone call between the electronic devices 101, 102, 103 and the server computer 115.

In alternative or additional implementations, the server computer 114 may communicate with one or more product-related data sources 117. According to embodiments, the product-related data sources(s) 117 may alternatively or additionally receive, access, store, and/or maintain various product profiles. Additionally, the product-related data source(s) 117 may be associated with businesses, companies, service providers, or the like, that may have an agreement, partnership, or contract with an entity associated with the server computer 115, and that offer or contemplate offering various products. Generally, when a business, company, service provider, or the like issues a new or updated product profile, the corresponding product-related data source 117 may push or otherwise send the new or updated product profile to the server computer 115, or the server computer 115 may pull or retrieve the new or updated product profile from the corresponding product-related data source 117. Accordingly, the server computer 115 may store the most up-to-date product profiles issued by the participating businesses, companies, services providers or the like, and may additionally maintain the product profiles. For example, the server computer 115 may store the product profiles such that the profiles may serve as an environment where data related to the product profiles may be created, edited, stored, and/or updated as part of the product profile.

The server computer 114 may additionally communicate with a regulation-related data source(s) 116 and a non-regulatory data source(s) 118. According to embodiments, the regulation-related data source(s) 116 may be associated with various regulatory bodies or agencies that may set or institute product regulation updates. For example, the regulation-related data source(s) 116 may be associated with the U.S. Consumer Product Safety Commission (CPSC), the U.S. Environmental Protection Agency (EPA), the U.S. Federal Aviation Administration (FAA), the U.S. Federal Communications Commission (FCC), the U.S. Food and Drug Administration (FDA), the U.S. Federal Trade Commission (FTC), the U.S. National Highway Traffic Safety Administration (NHTSA), the U.S. Nuclear Regulatory Commission (NRC). The regulatory bodies or agencies may be any combination of federal-level, state-level, municipal-level, local-level, foreign, or other level of regulatory bodies or agencies. Generally, when a regulatory body or agency issues a new or updated product regulation update, the corresponding regulation-related data source 116 may push or otherwise send the new or updated product regulation update to the server computer 115, or the server computer 115 may pull or retrieve the new or updated product regulation update from the corresponding regulation-related data source 116. Accordingly, the server computer 115 may store the most up-to-date product regulation updates issued by the participating regulatory bodies or agencies.

According to embodiments, the server computer 115 may employ various machine learning techniques, calculations, algorithms, and the like to generate and maintain a machine learning model associated with regulations and protocols for a set of products for a given market(s). The server computer 115 may initially train the machine learning model using a set of training data, or may not initially train the machine learning model. The server computer 115 may analyze any product profile information received from the electronic devices 101, 102, 103, 104 and/or the product-related data source(s) 117, for example using the machine learning model, to determine any regulations that may apply to the corresponding product(s). The server computer 115 may avail the result(s) of the analysis (e.g., by presenting the result(s) in a user interface) for review and further selection by a user of the server computer 115. These functionalities are further described with respect to FIG. 1B.

The server computer 115 may be configured to interface with or support a memory or storage 113 capable of storing various data, such as in one or more databases or other forms of storage. According to embodiments, the storage 113 may store data or information associated with any machine learning models that are generated by the server computer 115, any product regulation update information received from the regulation-related data sources 116, or any product profile information received from the electronic devices 101, 102, 103, 104 or from the product-related data source(s) 117. Additionally, the server computer 115 may store data associated with the review of regulation updates determined to potentially be applicable to products.

Although depicted as a single server computer 115 in FIG. 1A, it should be appreciated that the server computer 115 may be in the form of a distributed cluster of computers, servers, machines, or the like. In this implementation, the entity may utilize the distributed server computer(s) 115 as part of an on-demand cloud computing platform. Accordingly, when the electronic devices 101, 102, 103, 104 interface with the server computer 115, the electronic devices 101, 102, 103, 104 may actually interface with one or more of a number of distributed computers, servers, machines, or the like, to facilitate the described functionalities.

Although four (4) electronic devices 101, 102, 103, 104, and one (1) server computer 115 are depicted in FIG. 1A, it should be appreciated that greater or fewer amounts are envisioned. For example, there may be multiple server computers, each one associated with a different entity. FIG. 1B depicts more specific components associated with the systems and methods.

FIG. 1B is an example environment 150 in which product regulation update data 151 is processed into regulation update applicability data 152 via a regulation update aggregation platform 155, according to embodiments. The regulation update aggregation platform 155 may be implemented on any computing device, including the server computer 115 (or in some implementations, one or more of the electronic devices 101, 102, 103, 104) as discussed with respect to FIG. 1A. Components of the computing device may include, but are not limited to, a processing unit (e.g., processor(s) 156), a system memory (e.g., memory 157), and a system bus 158 that couples various system components including the memory 157 to the processor(s) 156.

In some embodiments, the processor(s) 156 may include one or more parallel processing units capable of processing data in parallel with one another. The system bus 158 may be any of several types of bus structures including a memory bus or memory controller, a peripheral bus, or a local bus, and may use any suitable bus architecture. By way of example, and not limitation, such architectures include the Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

The regulation update aggregation platform 155 may further include a user interface 153 configured to present content (e.g., information associated with product profiles and potentially applicable product regulation updates). Additionally, a user may make selections to the content via the user interface 153, such as to navigate through different information, select and review applicable product regulation updates, select whether product regulation updates are applicable, and/or other actions. The user interface 153 may be embodied as part of a touchscreen configured to sense touch interactions and gestures by the user. Although not shown, other system components communicatively coupled to the system bus 158 may include input devices such as a cursor control device (e.g., a mouse, trackball, touch pad, etc.) and keyboard (not shown). A monitor or other type of display device may also be connected to the system bus 158 via an interface, such as a video interface. In addition to the monitor, computers may also include other peripheral output devices such as a printer, which may be connected through an output peripheral interface (not shown).

The memory 157 may include a variety of computer-readable media. Computer-readable media may be any available media that can be accessed by the computing device and may include both volatile and nonvolatile media, and both removable and non-removable media. By way of non-limiting example, computer-readable media may comprise computer storage media, which may include volatile and nonvolatile, removable and non-removable media implemented in any method or technology for storage of information such as computer-readable instructions, routines, applications (e.g., a regulation update aggregator application 160), data structures, program modules or other data.

Computer storage media may include, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the processor 156 of the computing device.

The regulation update aggregation platform 155 may operate in a networked environment and communicate with one or more remote platforms, such as a remote platform 165, via a network(s) 162, such as a local area network (LAN), a wide area network (WAN), telecommunications network, or other suitable network. The platform 165 may be implemented on any computing device, including one or more of the electronic devices 101, 102, 103, 104 or the server computer 115 as discussed with respect to FIG. 1A, and may include many or all of the elements described above with respect to the platform 155. In some embodiments, as will be described herein, the regulation update aggregator application 160 as will be further described herein may be stored and executed by the remote platform 165 instead of by or in addition to the platform 155.

The regulation update aggregation platform 155 may store, as profile and regulation data 164, any information associated with product profiles and product regulations, such as the received product regulation update data 151. Additionally, the regulation update aggregator application 160 may employ machine learning techniques such as, for example, a regression analysis (e.g., a logistic regression, linear regression, or polynomial regression), k-nearest neighbors, decision trees, random forests, boosting, neural networks, support vector machines, deep learning, reinforcement learning, latent semantic analysis, Bayesian networks, graph-embeddings, semantic matching energy, self-supervised learning and weak supervision models, or the like. Generally, the regulation update aggregation platform 155 may support various supervised and/or unsupervised machine learning techniques. Additionally, the regulation update aggregation platform 155 may employ topic modeling and clustering of the profile and regulation data 164, which may enable the vast and diverse set of regulations to be narrowed to a more relevant set of regulations that may be applicable to the product and/or to a given market(s) for the product. In an embodiment, the regulation update aggregator application 160 may initially train a machine learning model with training data, and store the resulting machine learning model as machine learning model data 163. In another embodiment, the regulation update aggregator application 160 may generate and update the machine learning model, and the corresponding machine learning model data 163, based on the received product regulation update data 151, and in some cases may generate the machine learning model using various unsupervised training techniques, such as clustering or cluster analysis and could also take “guidance” information from subject matter experts (SME) which could augment the resulting data with qualifying metadata or contextual information.

For example, the regulation update aggregator application 160 may generate and update the machine learning model to include a semantic knowledge graph, included in the machine learning model data 163. The semantic knowledge graph may be a contextual model trained on and/or updated by an online and/or offline process that represents the interconnections between regulations and protocols, but training the semantic knowledge graph may also take place during the online functionality of the regulation update aggregator application 160. The regulation update aggregator application 160 may generate such a semantic knowledge graph by parsing protocol data (e.g., from the protocol and regulation data 164).

Initially, the protocol data may be in a non-standardized, customer-specific format, so the regulation update aggregator application 160 may standardize the protocol data during the parsing process to determine a number of schema. The dynamic schema may include, by way of non-limiting example, customer name, profile scope, regulation summaries, market of the profile, product category, test method details, profile creation date, profile revision data, and/or any other desirable identifying information. This training process may be repeated for the applicable regulations from the protocol and regulation data 164, and may be dynamically performed in its entirety as, for example, the regulation update aggregation platform 155 receives the product regulation update data 151.

According to embodiments, when the regulation update aggregation platform 155 receives the data 151, such as for a new or updated regulation, the regulation update aggregator application 160 may analyze the data 151 to determine what, if any, of the product regulation updates may apply to a product. In analyzing the data 151, the regulation update aggregator application 160 may use any combination of the protocol and regulation data 164 and the machine learning model data 163, including, for example, the semantic knowledge graph.

In an implementation, the regulation update aggregator application 160 may assign unique identifiers (IDs) to each schema stored in the machine learning model data 163. Once the regulation update aggregation platform 155 receives the product regulation update data 151, the regulation update aggregator application 160 parses the data 151 to produce a respective schema, and compares the respective schema to the schema stored in the machine learning model data 163. Based on the identified similarities, the regulation update aggregator application 160 may determine which of the product regulation updates may apply to the product, as well as a respective confidence level of the applicability for each identified product regulation update. In this way, the user can identify exactly what areas of the product regulation are undergoing change, and how the user may desire to change the associated product profiles accordingly.

In another implementation, the regulation update aggregator application 160 may parse the language of the product profile and compare the content of the product regulation updates to identify similarities. The level of similarity between the product profile and the product regulation updates may be modified so as to adjust the sensitivity of the analysis. Based on the identified similarities, the regulation update aggregator application 160 may determine which of the product regulation updates may apply to the product, as well as a respective confidence level of the applicability for each identified product regulation update.

In another implementation, the regulation update aggregator application 160 may generate an embedding or any other representation based on the content of the product profile, where the regulation update aggregator application 160 may analyze the embedding or any other representation in combination with the machine learning model data 163 to determine which of the product regulation updates may apply to the product, as well as a respective confidence level for each identified product regulation update. The results of any analyses by the regulation update aggregator application 160 may be embodied as the regulation update applicability data 152.

As an example, a product profile for a mattress may describe the dimensions and materials of the mattress, as well as various other regulatory requirements and beneficial voluntary requirements of the mattress. However, the product profile may not mention anything about the fire retardant capability of the mattress and/or its materials. In certain jurisdictions or areas, mattresses are required to comply with certain flame retardant regulations. When the regulation update aggregator application 160 analyzes the product profile for the mattress, the regulation update aggregator application 160 may not only identify product regulation updates that may be applicable to the mattress itself, but also product regulation updates that may be applicable to flame retardant capabilities of the mattress. In particular, the regulation update aggregator application 160 may determine that the mattress includes a foam material, and may determine, from the protocol and regulation data 164, that mattresses having a foam material may be subject to a certain flame retardant regulation. Accordingly, the regulation update aggregator application 160 may present the certain flame retardant regulation update for user review even though the product profile does not mention any flame retardant capabilities and even though the entity associated with the mattress may not know that the mattress is subject to flame retardant regulations.

After identifying potentially applicable product regulation updates for a product based on the product profile, the regulation update aggregator application 160 may add, to the machine learning model, the results from the analysis so that the regulation update aggregator application 160 may use the updated machine learning model in subsequent regulation update applicability determinations. In embodiments, results from an internal or manual review of the regulation update applicability analysis may additionally or alternatively be used to update the machine learning model.

The regulation update aggregator application 160 (or another component) may cause the regulation update applicability data 152 (and, in some cases, the originally-received data 151) to be displayed on the user interface 153 for review by the user of the regulation update aggregation platform 155. The user may select to review and/or modify the displayed data. For instance, a user may review a product profile in comparison to the potentially applicable product regulation updates, and select which of the product regulation updates are actually applicable, which may be to contextualize to a vision of the target marketplace, market segment, or audience. For instance, if a product profile is associated with a launch of a set of headphones in the United States, and the potentially applicable product regulation updates include a noise output regulation applicable to the United States and a comparable regulation applicable to China, the user may select the United States regulation as applicable and the China regulation as not applicable. The regulation update aggregator application 160 may update the data model stored in the machine learning model data 163 to reflect any selections made by the user, for subsequent use by the regulation update aggregator application 160.

The present embodiments further describe a seeding approach inspired in neural machine translation that predicts alignment candidates by exploiting the hierarchical path similarity of a node in a source taxonomy (e.g., a vendor-specific product taxonomy), and that of another node in a target product taxonomy (e.g., GPC). More specifically, the described seeding approach leverages a machine-translation-style neural sequence-to-sequence architecture trained on the sequences of node labels obtained by traversing the GPC taxonomy in a top-to-bottom fashion. Given a specific node of interest in a source taxonomy, the described systems and methods accept as input the sequence of labels of nodes visited by traversing the source taxonomy from its root node to this node of interest. The systems and methods will then output the most similar hierarchical path traversal sequence of equivalent labels in GPC. The source sequence and the predicted target sequence can be interpreted as taxonomic alignments between the two taxonomies. It should be appreciated that entities may be matched when a given entity is not necessarily part of a taxonomy yet.

According to embodiments, the input may be any unstructured information and the output may be the best-aligned information from a knowledge graph. Embodiments may vary by limitations placed on user input within the application, which may in turn yield tailored queries to certain domains (sub-graphs) within the graph (e.g. GPC, HS, eClass, or another hierarchical information system).

The systems and methods may incorporate a machine-translation approach having an unsupervised machine learning algorithm to perform taxonomy alignment because it may learn directly from the structure of the target taxonomy. The target taxonomy has a hierarchical structure in which product categories are identified by a sequence of unique codes, which also have associated descriptions in human language. The equivalent labels in the source taxonomy need not be textually identical, but are likely similar so as to enable the algorithm to predict alignment, as the systems and methods may accommodate synonymy and other non-textually exact similarities through its reliance on word embeddings. The systems and method may be used to generate training data for Deep Graph Matching Consensus (DGMC).

According to embodiments, a two-step mapping method using data available from GS1 and the Web Data Commons (WDC) may be employed. In an RI use case, this two-step mapping method may be used to extract candidate mappings from a vendor-specific taxonomy and GPC, where these candidate mappings may be reviewed by subject matter experts.

Generally, work on graph and taxonomy mapping can be divided into three broad families: Link Prediction (LP), Entity Alignment (EA), and Ontology Matching (OM). LP seeks to complete a graph by suggesting additional links between the nodes already present in the graph. Conversely, EA and OM intend to establish correspondences or links between two or more separate graphs. The main difference between EA and OM is that OM seeks correspondences between instances and data properties in different ontologies, whereas EA focuses on finding equivalent or almost equivalent nodes across the graphs. Thus, OM is considered a broader and more complex problem than EA. Because RI use cases seek (near) equivalences between products, it may be addressed as an EA problem.

Most EA approaches are supervised. Examples include cross-graph embeddings and message passing, deep graph matching, and DGMC which combines ideas from these approaches with neighborhood consensus from the computer vision domain. DGMC may be used as a supervised method expecting that its refinement step could reduce the noise incurred during the unsupervised seeding step.

According to embodiments, regulations may be associated with products and their respective features by aligning regulations with standardized representations of entities such as product taxonomies, attribute taxonomies, chemical and material taxonomies, and the like. Further, these regulations entities may be represented in ontological format and queried using a knowledge graph to match regulations to products.

Generally, in embodiments, the systems and methods may support a knowledge graph that uses a graph-structured data model or topology to integrate data, where the knowledge graph may store interlinked descriptions of entities while encoding the semantics underlying the used terminology. In this regard, regulations and/or attributes may be defined and contextualized, and machine learning techniques may contribute to any enrichment of the knowledge graph. Alternatively or additionally, machine learning techniques may deliver analytics from the knowledge graph back to the knowledge graph, or to the user, but not necessarily operating directly from profiles.

Further, according to embodiments, the systems and methods may support ingesting product information including data acquisition and data cleaning to identify product attributes and establish component-product relationships. According to embodiments, regulations may be applicable due to product attributes, and not merely product categories. The systems and methods may use machine learning (e.g., using weak models) to train a model(s) that will automate category and attribute assignment in order to generate representations of products for automatically determining relevant standards, regulations, and requirements. Product taxonomies (or any information hierarchy) may be represented in a product profile or product protocol, or within the information systems that warehouse the descriptors which a profile or protocol may be tagged with. Machine learning-driven taxonomic mapping therefore allows user input to be disambiguated into its descriptors. Those matched descriptors can then be used in aggregate to assess whether a regulation might be relevant, given a set of matched descriptor entities, according to the structure of the requirements.

According to embodiments, the product information may include information from customers such as product name, description, attachments (including but not limited to product specifications, user manuals, bills of materials, etc.). Processing of this data may include scanning, formatting, sending information to ML or AI models to extract or predict information, aligning predicted or extracted entities with known entities, and performing other functionalities. The models include, but are not limited to, Named Entity Recognition and Disambiguation Models to identify and normalize product categories, components, chemicals, materials, and product attributes, as well as a multi-label classifier model to classify products into the GS1 product taxonomy. Additionally, there are Value Parser & Relation Extraction NER models, where the goal of these models is to extract terms based on terms that may cause regulation or standard requirements to apply.

The systems and methods envision ingesting customer product catalogs in bulk to bulk create profiles. Additional classification schemes other than GS1 such as HS Codes or other taxonomies are envisioned. Additionally, NER models may be expanded to cover additional entities such as, but not limited to, product categories, components, chemicals, materials and product attributes. Lastly, additional models may be developed to assist with automatically determining key features about a product that may cause regulations, standards, or requirements to apply.

Additionally, in embodiments, the systems and methods may use product profile and attribute information, including sub-component information, to evaluate potential certification performance using past certification results.

Implementations of these embodiments may include, but are not limited to: predicting compliance of an existing product certified to X standard in Y Market to a new standard Z in an alternate market, based on how it performed against X standard; predicting compliance of a new model of an existing product (e.g., with a new component) to the same standard a previous model was certified to; predicting overall compliance of a product based on how its components performed to their respective standard(s); and predicting how likely it is a product may pass certification requirements based on overall risk of a product (e.g. a product with electrical components may be perceived as more risky than a product without, etc.).

According to embodiments, the input data may be in the form of a barcode or other type of identification (e.g., a global trade identification number (GTIN)) of a corresponding product, as well as an identification of a taxonomy of the product. The protocol aggregator platform 155 may extract product information (e.g., one or more categories, features, etc.) from this input data and use this product information to identify applicable product regulations. This data may be stored by the protocol aggregator platform 155 such that when a user or customer requests data (e.g., in response to a scanning of a product), the protocol aggregator platform 155 may provide various portions of this stored information to the user or customer, for example via the user interface 153.

Additionally, in embodiments, the protocol aggregator platform 155 may analyze various of the input data 151 to dynamically and automatically predict or determine new regulations (or standards, requirements, etc.) that may apply to a corresponding product, including any components of the product, intended use(s) of the product, a context(s) in which the product is used, and/or the like. Additionally or alternatively, the protocol aggregator platform 155 may dynamically and automatically predict or determine which regulations/standards/requirements/etc. no longer apply to the product or its components, as well as dynamically and automatically predict or determine which regulations/standards/requirements/etc. that previously did not apply to the product or its components but now potentially apply to the product or its components. The protocol aggregator platform 155 may notify a user of any of these determinations and/or may automatically update a profile associated with a given product.

Further, in embodiments, the protocol aggregator platform 155 may support the adding of comments and information to any of the regulations (or standards, requirements, etc.). In particular, the protocol aggregator platform 155 may automatically initiate and display a comment entry dialog in response to detecting, for example, a selection of text in an HTML representation of a regulation, standard, requirement, or the like, where the comment or entry may be accessible and viewed by all or some users of a given tenant. Additionally, the comment or entry may include information about a profile, regulation, standard, requirement, or the like, and may tag one or more specific users which may cause the protocol aggregator platform 115 to notify the user(s) that there is a comment or information to review. In embodiments, the comments may be used to facilitate workflow and may be edited or removed as applicable.

Further, in embodiments, the systems and methods may support an application interface for customer entry of product data and countries of regulatory significance in order to automatically generate a product profile and attributes that are used to identify relevant product regulations in each country.

Generally, the interface may include a step-wise process where a user may enter a product name, description, and countries of interest as well as attachments (including but not limited to product specifications, user manuals, bills of materials, etc.). These inputs may be sent via the application interface to ML and AI models to be scanned and entities that cause regulations or standards to apply are predicted and supplied to the user for review. A user may review and opt to remove these entities or add new or other existing entities from a list to their profile. Once all relevant entities are selected, the interface may query a knowledge graph to identify applicable regulations, standards, and/or requirements based on the provided entities. A profile may be created with suggested regulations, standards, customer standards, and/or requirements where users may review and remove the predicted items and/or search for and add additional regulations, standards, customer standards, and/or requirements. Future implementations could feature additional automation or ability to upload a product catalog or pull from a customer catalog directly.

Additionally, in embodiments, the systems and methods may automatically determine a product classification and detailed product attributes based on information entered via a user interface by a customer.

Product information may include information from customers such as product name, description, attachments (including but not limited to product specifications, user manuals, bills of materials, etc.). Processing of this data may include scanning, formatting, sending information to ML or AI models to extract or predict information, align predicted or extracted entities with known entities, and/or perform other analyses.

The models may include Named Entity Recognition & Disambiguation Models to identify and normalize product categories, components, chemicals, materials, and product attributes, as well as a multi-label classifier model to classify products into the GS1 product taxonomy. Additionally or alternatively, the models may include Value Parser & Relation Extraction NER models. The goal of these models may be to extract terms based on terms that may cause regulation or standard requirements to apply.

Future state may include additional classification schemes other than GS1 such as HS Codes or other taxonomies. Additionally, NER models may be expanded to cover additional product categories, components, chemicals, materials and product attributes. Lastly, additional models may be developed to assist with automatically determining key features about a product that may cause regulations, standards, or requirements to apply.

In an additional embodiment, the systems and methods may identify a need for a new standard or regulation based on an assessment of activity by regulatory information customers.

In particular, the systems and methods may track and record activity of customers and users of the system including, but not limited to, the regulations commonly applied to or removed from a product or series of products, the content of customer requirements created (e.g. many customers opt to meet lower lead requirements even though regulations supply a less restrictive lead limit, etc.). Based on this activity, analytics may be generated and data may be reviewed to suggest the need for standards or regulations to be generated or updated to account for customer activity/behavior. Based on customer use and addition of new data, ML/AI models may be updated and the knowledge graph may be improved with customer input. For example, if customers consistently add new product attributes, the models may be expanded to cover these attributes and the knowledge graph would include them in its ontology. Future state could integrate with governments and/or standards organizations and lobby for new bills/regulations/standards to be created to address unmet needs.

Further still, the systems and methods may support a user interface that provides a consolidated method of entering comments/annotations, country/market, regulations, standards, and requirements, wherein the customer can add custom requirements and review full text of standards and regulations generated across standards development organizations, including push notifications identifying standard/regulation updates. Generally, customers may use a single system as a source of truth for regulatory and standard compliance needs, including tracking of updates and opting to change their product testing programs as needed in light of updated requirements.

Additionally, the systems and methods may support a user interface including the ability to interface directly with certification organization representatives. This may include the ability to interact directly with certification organization representatives via a chat system or comments, such as regarding interpretation of a standard or a regulation and how it applies to a customer or not. Future implementations may include ability to direct users to certification or testing work with UL based on their questions/requests.

Moreover, the systems and methods may support a user interface having the ability to automatically or manually solicit regulatory or certification advice from certification subject matter experts.

In particular, this may include the ability for a user to submit a question or a comment, select a topic or area of expertise needed (e.g. toys, consumer products, smart appliances, Italian market, etc.), and request advice. This may additionally include the ability for subject-matter experts to manage intake of requests and associated workflow, assignment to users and fulfillment of request, as well as integration with third party software to manage requests. Additionally, this may involve using ML/AI over any incoming requests to determine the context of the question and route it automatically to the corresponding SME best suited to answer the question and/or using the user's IP address to identify a user's country and regional language to route to an SME with the same corresponding language. Future implementations may include ability to direct users to certification or testing work with UL based on their questions/requests.

In general, a computer program product in accordance with an embodiment may include a computer usable storage medium (e.g., standard random access memory (RAM), an optical disc, a universal serial bus (USB) drive, a big data processing engine, a NoSQL repository, or the like) having computer-readable program code embodied therein, wherein the computer-readable program code may be adapted to be executed by the processor 156 (e.g., working in connection with an operating systems) to facilitate the functions as described herein. In this regard, the program code may be implemented in any desired language, and may be implemented as machine code, assembly code, byte code, interpretable source code or the like (e.g., via Golang, Python, Scala, C, C++, Java, Actionscript, Objective-C, Javascript, CSS, XML). In some embodiments, the computer program product may be part of a cloud network of resources. Generally, each of the data 151 and the data 152 may be embodied as any type of electronic document, file, template, etc., that may include various textual content and, for the data 152, an identification of the potentially applicable product regulation updates for a given product, and may be stored in memory as program data in a hard disk drive, magnetic disk and/or optical disk drive in the regulation update aggregation platform 155 and/or the remote platform 165.

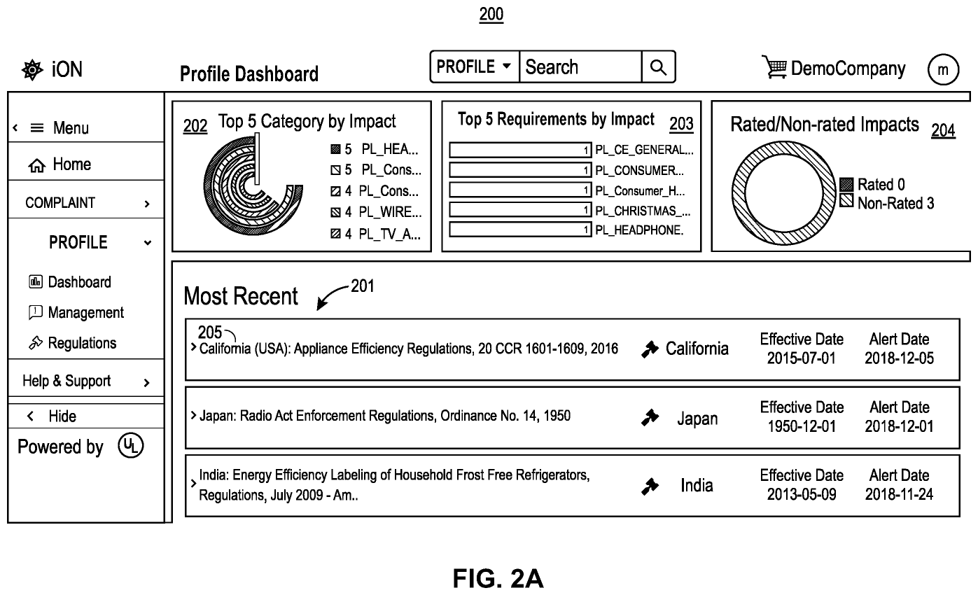

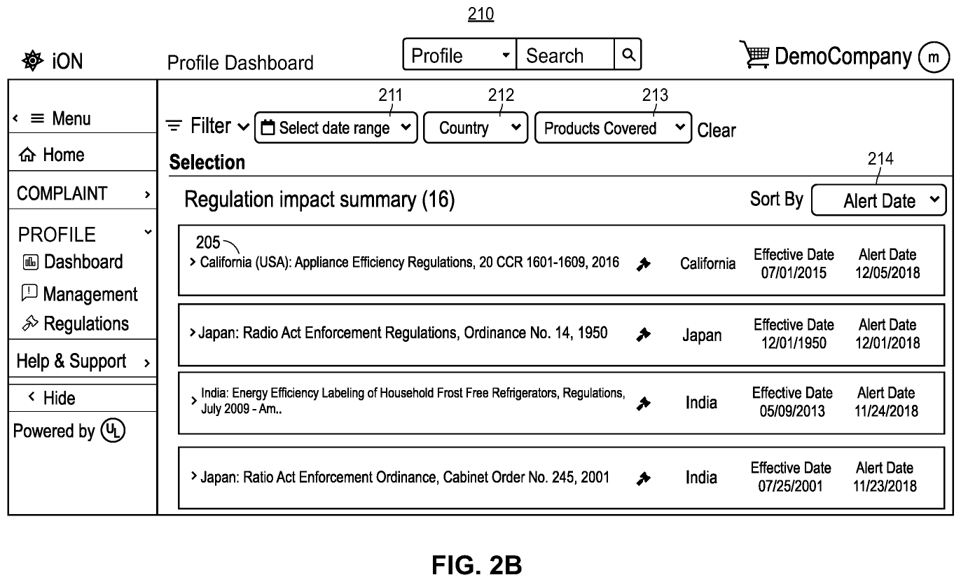

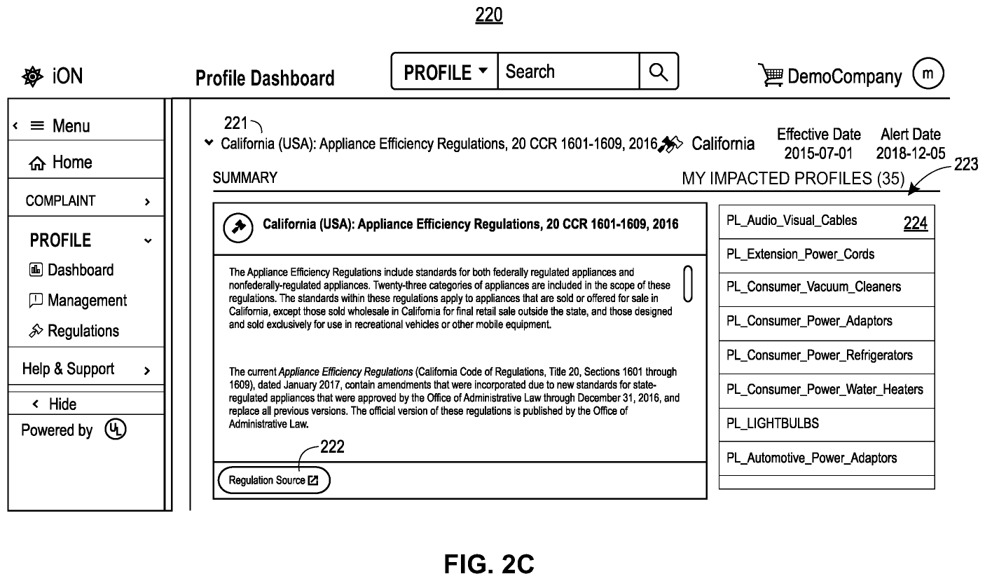

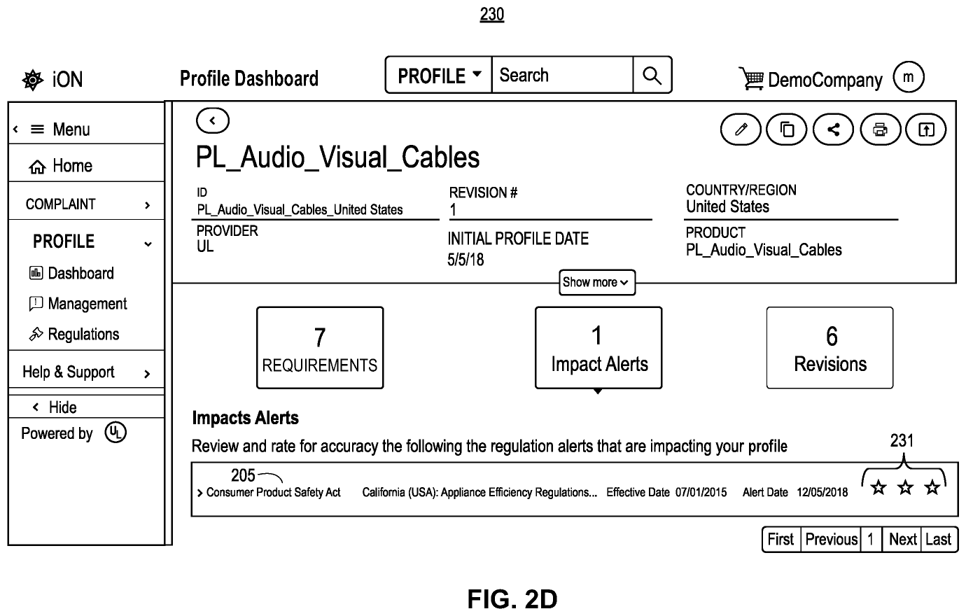

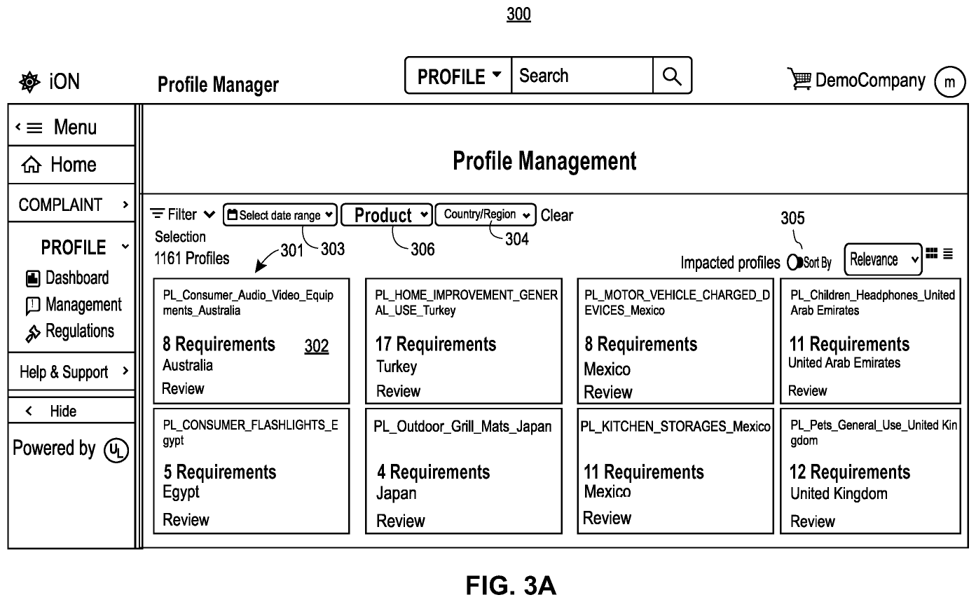

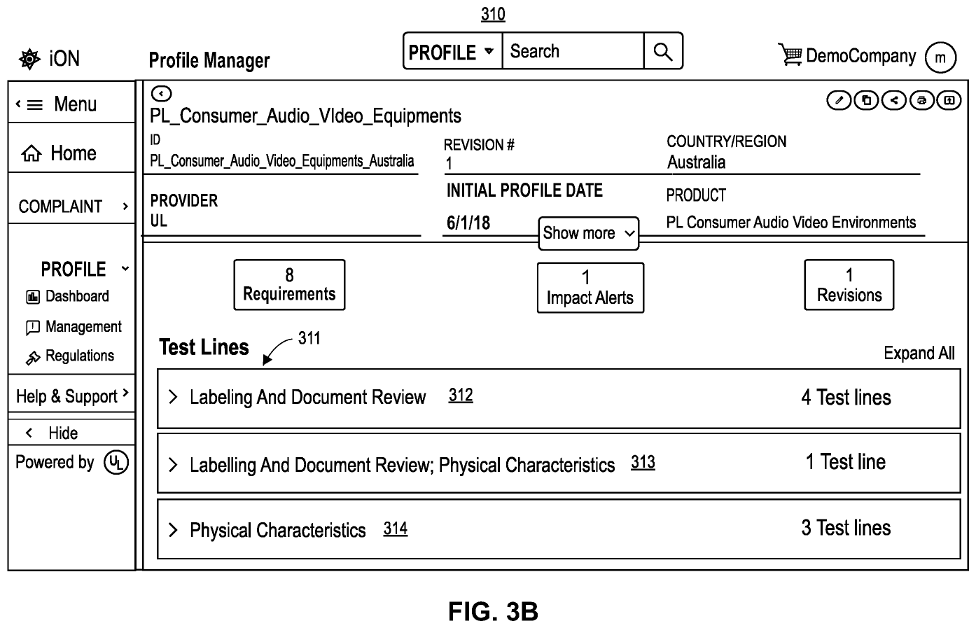

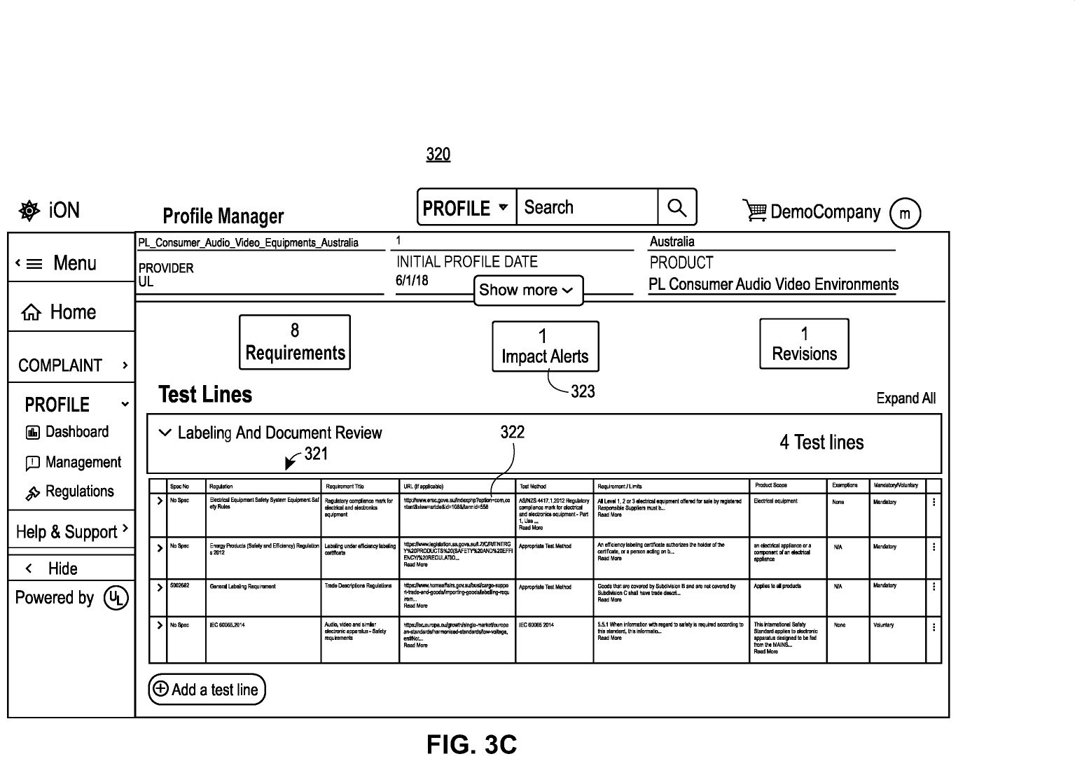

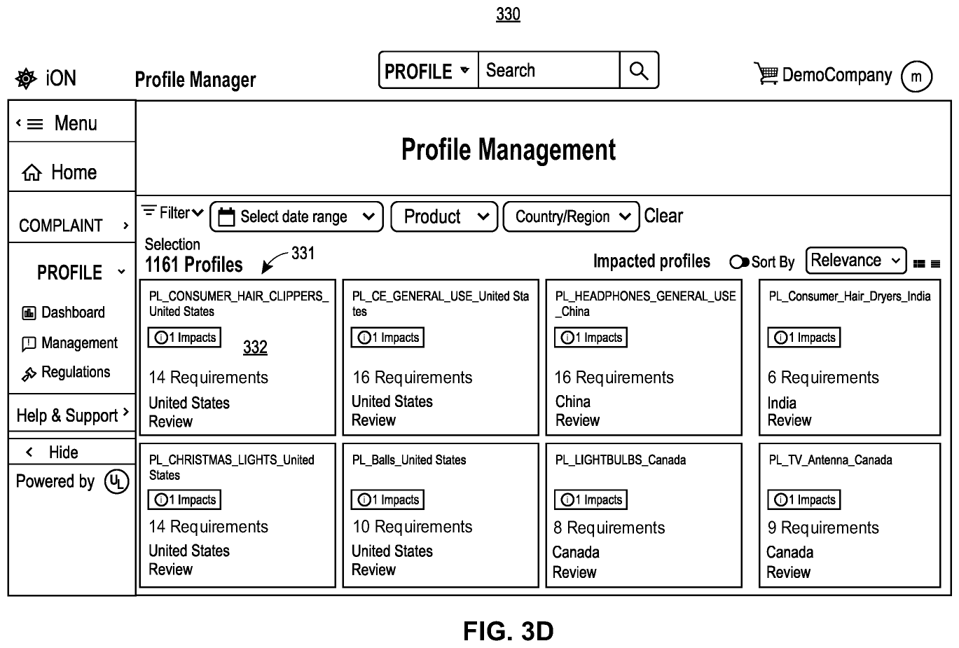

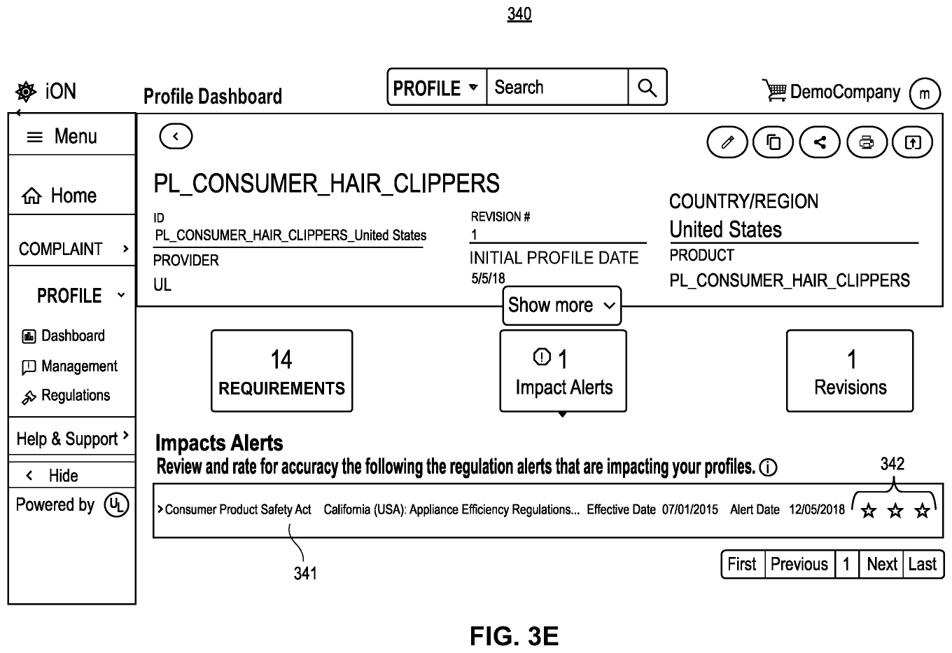

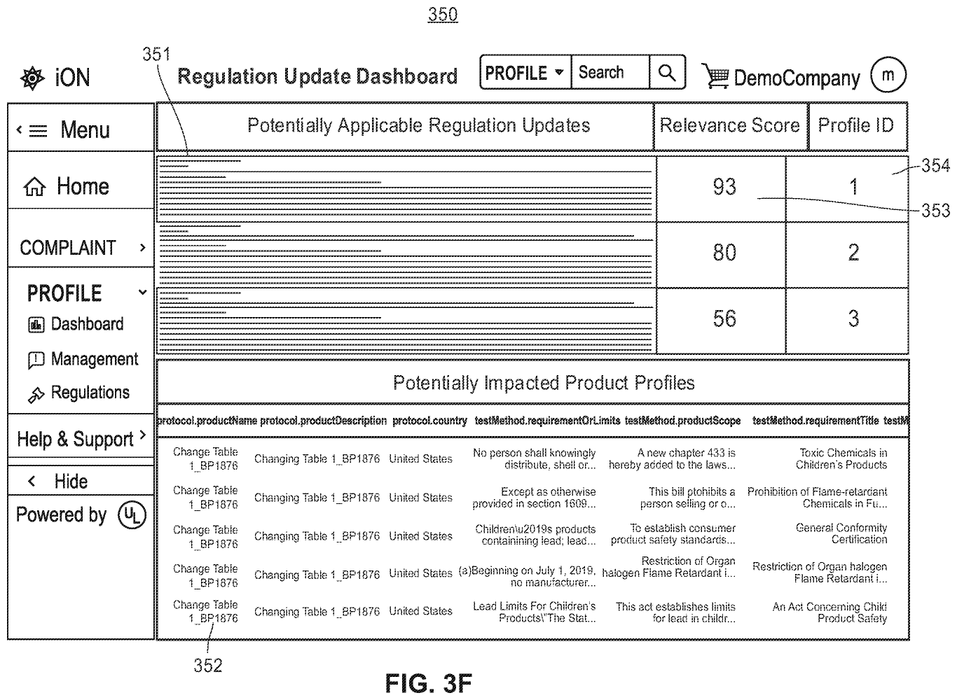

FIGS. 2A-2D and 3A-3F depict example interfaces associated with the systems and methods. In embodiments, the interfaces may be displayed by a computing device in a user interface, such as the user interface 153 as discussed with respect to FIG. 1B. Additionally, the interfaces may be accessed and reviewed by a user of the platform (e.g., the platform 155), where the user may make selections, submit entries or modifications, or facilitate other functionalities.

FIG. 2A depicts an interface 200 associated with the systems and methods. In particular, the interface 200 depicts a set of regulations 201 having recent updates (as shown: Appliance Efficiency Regulations of California, Radio Act Enforcement Regulations of Japan, and Energy Efficiency Labeling of Household Frost Free Refrigerators, Regulations of India). Each of the set of regulations 201 has an effective date (i.e., when the regulation itself became effective), an alert date (i.e., when the regulation update alert was received), and a most recently updated date (i.e., when the regulation was last updated).

The interface 200 further indicates a set of product categories 202 (as shown: general use headphones, consumer power refrigerators, consumer hair dryers, wireless devices, and TV antennas) and a set of requirements 203 (as shown: general consumer electronics in the United States, consumer hair clippers in the United States, consumer hair dryers in India, Christmas lights in the United States, and headphones in China) for which the largest amount of potentially applicable regulatory updates have been surfaced. The interface 200 also provides an overview of the most recently added potential regulatory impacts to the set of regulations 201. Additionally, the interface 200 includes a chart 204 identifying the count of rated impacts and non-rated impacts (e.g., impacts that have been independently verified).

The interface 200 enables a user to select to view additional regulations, in which case the computing device may display an interface 210 as depicted in FIG. 2B. The interface 210 enables the user to select various filters, including a date range 211, an applicable country 212 (i.e., view regulation updates specific to specific countries), and a type(s) of products covered by the regulations 213. Additionally, the interface 210 enables the user to sort by an alert date 214.

The interface 200 further enables the user to select specific regulatory updates of the set of regulations 201 to review additional information. For example, the user may select the Appliance Efficiency Regulation 205, in which case the computing device may display an interface 220 as depicted in FIG. 2C. The interface 220 may include a summary 221 of the selected regulation and a selection 222 to view the source of the regulation or update. Additionally, the interface 220 may include a set of profiles 223, each of which is impacted by or potentially impacted by the selected regulatory update.

One of the set of profiles 223 may be a profile 224 for audio visual cables. The user may select the profile 224, in which case the computing device may display an interface 230 as depicted in FIG. 2D. The interface 230 may including various information identifying and describing the profile. Additionally, the interface 230 may indicate the Appliance Efficiency Regulation 205 which may be applicable to the profile 224, and may enable the user to select whether the Appliance Efficiency Regulation 205 is actually applicable to the profile 224. For example, the interface 230 may include a star rating system 231 where the user may select one (1) star if the profile 224 is not impacted by the regulation 205 and three (3) stars if the profile 224 is impacted by the regulation 205. The computing device may associate, in memory, the selected rating with the regulation 205 and with the profile 224. The user may select and rate the regulation applicability of any of the remaining protocols in the set of profiles 223 depicted in FIG. 2C.

FIG. 3A depicts an interface 300 associated with the “Management” feature of the regulation update aggregation platform 155. The interface 300 may include a set of profiles 301 that a user may select to review and assess regulation update applicability, among other actions. The interface 300 enables the user to select various filters for the set of profiles 301, including a date range 303, an applicable country or region (i.e., view profiles specific to specific countries/regions) 304, and a type(s) of products covered by the profiles 306. As an example, the user may select to review a profile 302 associated with consumer audio and video equipment in Australia, in which case the computing device may display an interface 310 as depicted in FIG. 3B.

The interface 310 of FIG. 3B identifies a set of requirement categories 311 (as shown: labeling and document review 312, physical characteristics of labeling and document review 313, and physical characteristics 314) for a set of requirements for various regulations, standards, and/or customer requirements. In response to the user selecting the labeling and document review 312 category, the computing device may display an interface 320 as depicted in FIG. 3C.

The interface 320 of FIG. 3C identifies a set of regulations 321 that are deemed applicable to the labeling and document review 312 category. The user may make various selections in the interface 320 to review certain information. For example, the user may select a URL 322 of the Electrical Equipment Safety System Equipment Safety Rules of Australia to review the content of that regulation. The interface 320 further includes an impact alerts selection 323 that enables the user to select an applicability of a set of regulations that are not yet deemed applicable to the selected profile. In the interface 320 depicted in FIG. 3C, there are not any regulations for which an applicability determination is needed.

The interface 300 of FIG. 3A may further include a selection 305 to filter impacted profiles, where in response to a user selecting the selection 305, the computing device may display an interface 330 as depicted in FIG. 3D. The interface 330 may identify a set of profiles 331 that are potentially impacted by certain regulations (or updates to the regulations). The user may select a profile 332 related to consumer hair clippers in the United States. In response, the computing device may display an interface 340 as depicted in FIG. 3E.

The interface 340 may identify a regulatory update 341 (the Consumer Product Safety Act) that was recently updated and that may apply to the consumer hair clipper profile 332. The user may select whether the regulatory update 341 applies to the consumer hair clipper profile 332 by using a star rating system 342, as discussed with respect to FIG. 2D. After the user selects a rating in the star rating system 342, the computing device may associate (or not associate) the regulatory update 341 with the consumer hair clipper profile 332.

The interface 350 of FIG. 3F identifies a set of potentially applicable product regulation updates 351 and the corresponding potentially applicable product profiles 352. The interface 350 also features relevance scores 353 and product profile identifiers (IDs) 354 associated with each potentially applicable product regulation update 351. For example, and as referenced further herein, the application (e.g., regulation update aggregator application 160) may parse received data to determine a confidence level with respect to the applicability of any regulation update to a particular product profile. The interface 350 may display this confidence level in the form of a numeric score (as shown, in reference to 353), a percentage, a confidence percentile, or any other suitable metric that the user may choose. Moreover, the interface 350 provides the corresponding profile IDs 354, which correspond to the product profiles 352. Using this information, the user may analyze the correlations made by the system to confirm or deny their applicability.

Accordingly, the system (e.g., regulation update aggregation platform 155) may update the analysis technique (e.g., semantic knowledge graph) to reflect the correct/incorrect association. For example, the system draws a correlation between a product profile and a regulation update due to a specific association of words relating to telecommunications equipment. However, the system categorizes it as a weak correlation (e.g., a low relevance score 353) because the telecommunication terminology used in both the profile and regulation update are the only shared terms. When a user confirms the applicability of the regulation update to the product profile, the system updates the semantic knowledge graph to more heavily weigh the inclusion of such telecommunication terminology in future analyses. In other words, the system may draw stronger correlations between a regulation update and product profile in future analyses when both the update and profile contain those specific telecommunication terms.

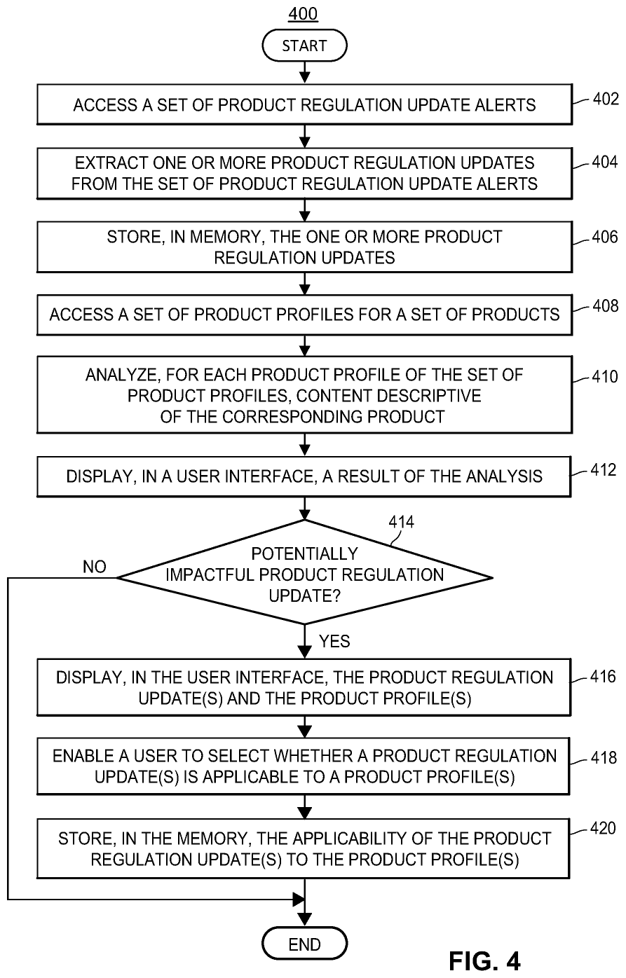

FIG. 4 depicts is a block diagram of an example method 400 for dynamically determining product regulation updates that are applicable to product profiles. The method 400 may be facilitated by an electronic device (such as the server computer 115 or components associated with the regulation update aggregation platform 155 as discussed with respect to FIGS. 1A and 1B) that may be in communication with additional devices and/or data sources.

The method 400 may begin when the electronic device accesses (block 402) a set of product regulation update alerts. In embodiments, the electronic device may receive the set of product regulation update alerts as product regulation updates from one or more sources (e.g., the regulation-related data source(s) 116 as discussed with respect to FIG. 1A).

The electronic device may extract (block 404) one or more product regulation updates from the set of product regulation update alerts. In embodiments, the electronic device may extract the one or more product regulation updates by parsing the one or more product regulation update alerts.

The electronic device may store (block 406), in memory, the set of product regulation updates. In embodiments, the electronic device may store the set of product regulation updates in the memory as part of a machine learning model. The electronic device may access (block 408) a set of product profiles for a set of products for a given market(s). In embodiments, the electronic device may receive the set of product profiles associated with new or existing products from one or more sources (e.g., the product-related data source(s) 117 as discussed with respect to FIG. 1A). Further, each product profile of the set of product profiles may include content descriptive of a corresponding product of the set of products for a given market(s).

The electronic device may analyze (block 410), for each product profile of the set of product profiles, the content descriptive of the corresponding product. In analyzing each product profile, the electronic device may analyze the content using the stored machine learning model built from the set of product regulations. The electronic device may display (block 412), in a user interface, a result of the analysis. In embodiments, the electronic device may display, in the user interface, indications of any of the product profiles and/or the product regulation updates.

In analyzing the content descriptive of the corresponding product, the electronic device may determine (block 414), for each product profile, whether there is a product regulation update(s) that is potentially applicable. If there are no potentially applicable product regulation updates (“NO”), processing may end or proceed to other functionality. If there is a potentially applicable product regulation update(s) (“YES”), processing may proceed to block 416.

At block 416, the electronic device may display, in the user interface, a list of product regulation update(s) and the product profile(s), such as any product regulation update(s) that is potentially relevant to the corresponding product profile(s). In embodiments, the electronic device may receive, via the user interface, a selection to view each product profile having at least one product regulation update that is potentially applicable, and the electronic device may display information associated with the selected product profile(s) and the potentially applicable product regulation update(s). In one scenario, the electronic device may display, in the user interface, a set of requirements or summaries associated with a selected product profile, and for each line item of the set of requirements or summaries, at least one product regulation update that is applicable to the line item.

In embodiments, the electronic device may transmit the information associated with the selected product profile(s) and the potentially applicable product regulation update(s) to additional connected systems. For example, the electronic device may transmit the information to external/internal servers, workstations, and/or any other suitable receiving device. In these embodiments, the transmitted information may be stored and/or used for design and development applications. Thus, once the data is transmitted, the systems receiving the information may be updated to incorporate the information in future analytics processes.

The electronic device may enable (block 418) a user to select whether a product regulation update(s) is applicable to a product profile(s). Based on the selection of block 418, the electronic device may store (block 420), in the memory, the applicability of the product regulation update(s) to the product profile(s). Accordingly, the electronic device may use the updated machine learning model that reflects accurate regulation applicability in subsequent analyses.

Inspiration for using neural machine translation for taxonomy mapping comes from the problem domain of hierarchical classification, where a hierarchical class may be represented as a sequence of node IDs. In the GPC product taxonomy, for example, a powered stationary exercise bicycle has a node ID of 10005815—Cycles (Powered), and a full taxonomic classification in the branch [71000000, 71010000, 71010800, 10005815]. The systems and methods may train a Seq2Seq model on examples of this sort, mapping the text label describing a target node (e.g., “powered stationary exercise bicycle”) to the sequence of node IDs representing the correct branch in the hierarchy. Accordingly, during training, a representation of the hierarchy may be learned.

In order to classify into the GPC product hierarchy, the systems and methods may train a model using a sequence-to-sequence architecture with attention on a set of text examples averaging ten (10) words per example (thirty (30) words max), each text labeled with a sequence of GPC codes. These labels may start from the segment and family GPC codes, and end with the class code, and sometimes with a brick code. The target sequence length may therefore be 3 or 4, for example. According to embodiments, training data may be acquired from GPC and a small set of product names (1,200) manually labeled with brick codes.

Generally, DGMC is a graph mapping method that learns mappings in two steps: first, it initially learns correspondences between two graphs via localized node embeddings. Then, it refines these initial correspondences via neighborhood consensus. This method may obtain state-of-the-art results in the task of multilingual DBPedia alignment. The present embodiments employ original DGMC code2 with default hyperparameter values, where the text label embeddings are initialized using the Spacy vector representation of each node label.

Experiments were conducted on publicly available datasets, including the WDC Product Categorization. The present system (Seq2Seq-DGMC in Table 1 below) takes the full Google Taxonomy and the GPC taxonomies as input, along with a set of seed mappings (predicted by Seq2Seq) used to train the DGMC model and outputs suggested mappings between the two taxonomies.

TABLE 1

| System | H@l | H@10 | System | H@1 | H@10 |
|---|---|---|---|---|---|
| Supervised-DGMC50 | .47 | .78 | Emb | .13 | .30 |
| Supervised-DGMC10 | .31 | .68 | Emb-DGMC | .09 | .23 |
| Lev | .04 | .11 | Seq2Seq | .26 | N/A |
| Lev-DGMC | .08 | .20 | Seq2Seq- | .31 | .63 |
| | | | DGMC | | |

Table 1 compares our system with these alternative configurations:

Supervised-DGMC50 which is a fully supervised baseline. This is a DGMC system trained on a 50% sample of the Google-GPC mappings and evaluated on the other 50%. Because it is fully supervised, it does not use any seeding;

Supervised-DGMC10: same as above but using 10% of the Google-GPC mappings as training data and the remaining 90% for evaluation;

Lev: An unsupervised mapping obtained by pairing nodes in the source and target taxonomies that minimise their labels' Levenshtein distance;

Lev-DGMC: A baseline that uses Lev's output as seed data to train DGMC;

Emb: An unsupervised mapping obtained by pairing nodes in the source and target taxonomies that maximise the cosine similarity of their labels' Spacy embeddings;

Emb-DGMC: A baseline that uses Emb's output as seed data to train DGMC;

Seq2Seq: An unsupervised mapping obtained by predicting GPC node sequences for each Google node label.

The H@1 (“Hits at 1”, i.e., accuracy) metric is the proportion of correct GPC node mappings for each node. The H@10 (“Hits at 10”) metric is the proportion of times that the correct GPC node mapping occurs in the top ten (10) predictions for each node. While H@1 may be a better measure of system accuracy, H@10 can be interpreted as a proxy measure of the effort required by experts to review and correct the mappings produced by a system: the higher a correct mapping is on the prediction list, the easier it should be for a subject matter expert to review a list of mapping suggestions. This indicates that the proposed Seq2Seq-DGMC system performs the best of the seeded systems in terms of both accuracy and ease of review.

While Supervised-DGMC50 obtained the best score in terms of both H@1 and H@10, it is not a viable an option in our use case, as it requires half of the total mappings to be predicted to be available upfront. A more realistic scenario, Supervised-DGMC10, requiring 10% of the total mappings to be available a priori, produced very similar results to the Seq2Seq-DGMC system.

Experiments showed that semi-supervised taxonomy mapping is possible by seeding supervised taxonomy mapping methods with the output of fully unsupervised methods. However, the results obtained in unsupervised, semi-supervised, and fully supervised configurations are still quite low, suggesting avenues for further work. One such avenue is modifying DGMC, which was originally designed for general graphs, to exploit the specific properties of taxonomies, such as their unidirectional hierarchical nature. It is possible to train the seeding Seq2Seq on previously mapped vendor-specific taxonomies, as well as train Seq2Seq and DGMC as a joint model (rather than in sequence). Moreover, it is possible to conduct retraining experiments using a Human-in-the-loop approach, so that the amount of manual correction work done by subject matter experts is reduced as they progress on their mapping work.

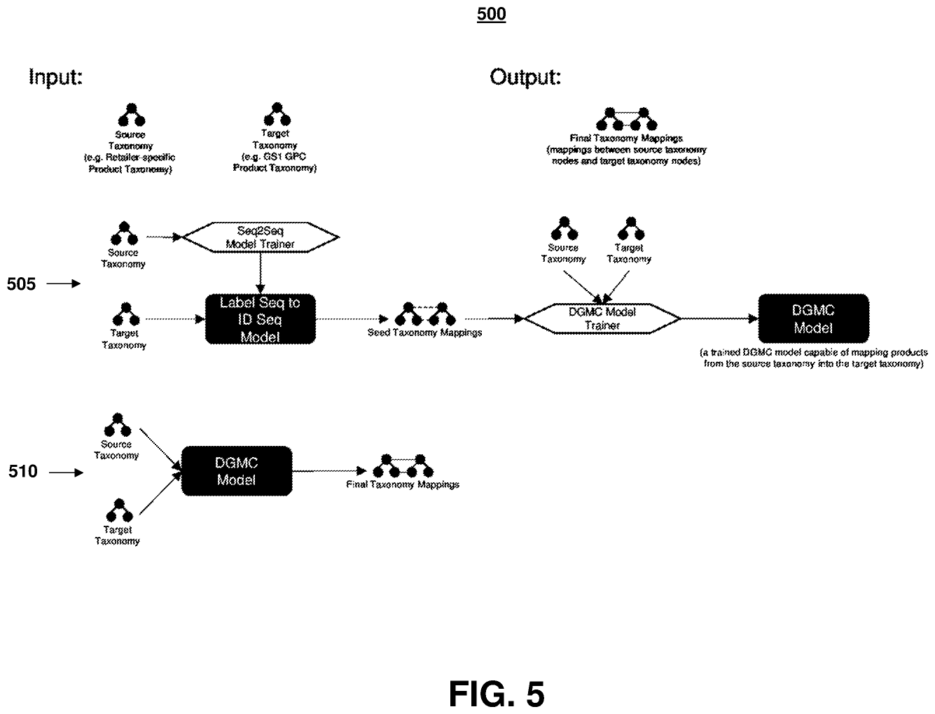

FIG. 5 depicts an overview 500 of datasets and components that access and analyze the datasets in association with the described taxonomy mapping embodiments. It should be appreciated that the additional or alternative datasets and components are envisioned.

Generally, the input datasets may comprise a source taxonomy (e.g., a retailer-specific product taxonomy) and a target taxonomy (e.g., GS1 GPC Product Taxonomy), and the output dataset may comprise a final taxonomy mapping, which may constitute mappings between source taxonomy nodes and target taxonomy nodes.

In the sequence 505 as illustrated in FIG. 5, the source taxonomy may be input into a Seq2Seq model trainer, the output of which along with the target taxonomy may be input into the label model (Seq to ID Seq), which results in a set of seed taxonomy mappings. The source taxonomy, the target taxonomy, and the seed taxonomy mappings are input into the DGMC model trainer, which outputs the DGMC model. According to embodiments, the DGMC model is a trained model capable of mapping products from the source taxonomy into the target taxonomy.

In the sequence 510 as illustrated in FIG. 5, the source taxonomy and the target taxonomy may be input into the DGMC model, an output of which may be the final taxonomy mappings.

Although the following text sets forth a detailed description of numerous different embodiments, it should be understood that the legal scope of the invention may be defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that may be permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that may be temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it may be communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

As used herein, the terms “comprises,” “comprising,” “may include,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible embodiment, as describing every possible embodiment would be impractical.

What is claimed is:

1. A computer-implemented method of using machine learning to map products, the method comprising:
training, by one or more computer processors, a machine learning model using a training dataset associated with a set of products, the training dataset comprising: (i) a training set of product descriptions associated with the set of products, and (ii) a training set of product classifications, in a universal knowledge graph, associated with the set of products;
storing the machine learning model in a memory;
accessing, by the one or more computer processors, information associated with a product, the information comprising (i) a product description, and (ii) a classification in a source knowledge graph;
analyzing, by the one or more computer processors using the machine learning model, the information associated with the product; and
based on the analyzing, outputting, by the machine learning model, a target classification, in the universal knowledge graph, for the product.

2. A computer-implemented method of using machine learning to map product taxonomies, the method comprising:
training, by one or more computer processors, a machine learning model using a training dataset associated with a set of products, the training dataset comprising: (i) a training set of product descriptions associated with the set of products, and (ii) a training set of product classifications, in a universal taxonomy, associated with the set of products;
storing the machine learning model in a memory;
accessing, by the one or more computer processors, information associated with a product, the information comprising (i) a product description, and (ii) a classification in a source taxonomy;
analyzing, by the one or more computer processors using the machine learning model, the information associated with the product; and
based on the analyzing, outputting, by the machine learning model, a target classification, in the universal taxonomy, for the product.

3. A system for using machine learning to map products, the system comprising:
a memory storing instructions;
a user interface; and
a processor interfaced with the memory and the user interface, and configured to execute the instructions to cause the processor to:
train a machine learning model using a training dataset associated with a set of products, the training dataset comprising: (i) a training set of product descriptions associated with the set of products, and (ii) a training set of product classifications, in a universal knowledge graph, associated with the set of products,
store the machine learning model in the memory,
access information associated with a product, the information comprising (i) a product description, and (ii) a classification in a source knowledge graph,
analyze, using the machine learning model, the information associated with the product, and
based on the analyzing, output, by the machine learning model, a target classification, in the universal knowledge graph, for the product.
